(19) United States
(12) Patent Application Publication
(10) Pub. No.: US 2015/0100191 A1
(43) Pub. Date: Apr. 9, 2015

(54) MONITORING AUTONOMOUS VEHICLE STEERING

(71) Applicant: Ford Global Technologies, LLC, Dearborn, MI (US)

(72) Inventor: Wilford Trent Yopp, Canton, MI (US)

(73) Assignee: Ford Global Technologies, LLC, Dearborn, MI (US)

(21) Appl. No.: 14/049,637

(22) Filed: Oct. 9, 2013

(51) Int. Cl. B62D 6/00; B60W 50/04

(52) U.S. Cl. CPC B62D 6/00; B60W 50/045
USPC 701/23

(57) ABSTRACT

A vehicle steering mechanism is autonomously operated. At least one first parameter for governing control of a steering mechanism is retrieved. The first parameter is applied to operation of the steering mechanism. Data is collected relating to operation of the vehicle. At least one second parameter for governing control of the steering mechanism is determined.

### BACKGROUND

A vehicle such as an automobile may be configured for autonomous driving operations. For example, the vehicle may include a central control unit or the like, i.e., the computing device having a processor and a memory, that receives data from various vehicle data collection devices such as sensors and generally also external data sources such as navigation information. The central control unit may then provide instructions to various vehicle components, e.g., actuators and the like that control steering, braking, acceleration, etc., to control vehicle operations without action, or with reduced action, by a human operator.

Autonomous and non-autonomous vehicles may be equipped with monitoring systems to detect faults in various vehicle sub-systems, such as a vehicle steering system. However, a vehicle steering system may be further affected by environmental conditions, which in turn can affect operation of the steering system as well as other vehicle systems, such as brakes, powertrain, etc. For example, phenomena such as high crowned roads, cross-winds, precipitation, terrain, etc. can affect vehicle responsiveness and performance. In a non-autonomous vehicle, a driver may compensate for phenomena affecting vehicle steering, and hence vehicle responsiveness and performance, sometimes without even being aware that a correction or adjustment is being made to steering. Further, an adjustment may vary depending on a direction in which a vehicle is being steered, i.e., turned in one direction or the other, being steered on a straight line, etc. However, mechanisms are lacking for making appropriate compensations to vehicle steering in autonomous vehicles.

### DRAWINGS

FIG. 1 is a block diagram of an exemplary autonomous vehicle system.

FIG. 2 is a diagram of an exemplary process for monitoring and/or controlling steering in an autonomous vehicle.

FIG. 3 is a diagram of steering rotation verses steering system assist force in the context of the exemplary system of FIG. 1.

### DETAILED DESCRIPTION

### System Overview

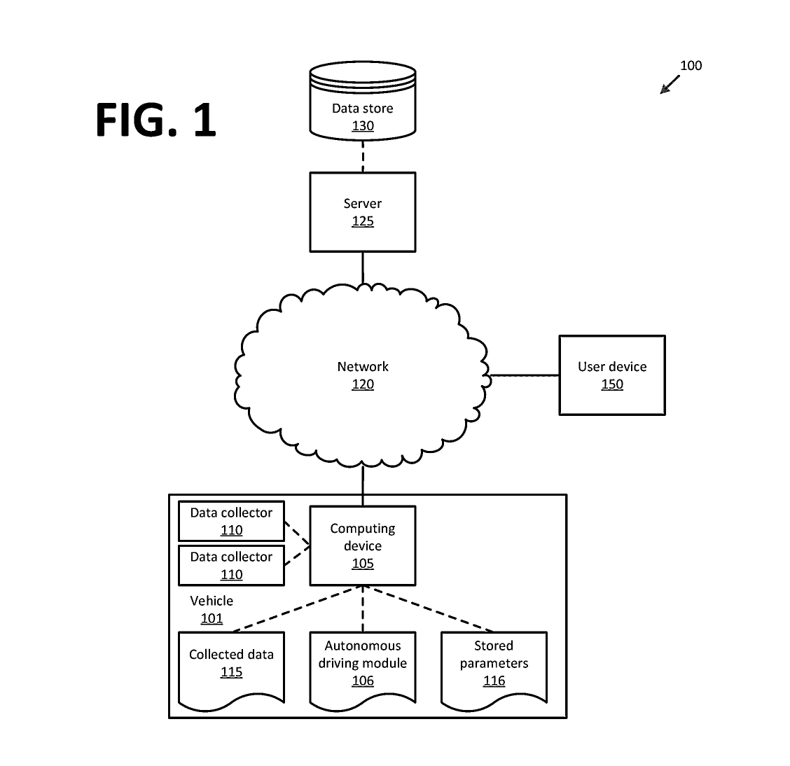

FIG. 1 is a block diagram of an exemplary autonomous vehicle system 100. A computer 105 may be configured for communicating with one or more remote sites such as a server 125 via a network 120, such remote site possibly including a data store 130. A vehicle 101 includes the vehicle computer 105 that is configured to receive information, e.g., collected data 115, from one or more data collectors 110 related to various components or conditions of the vehicle 101, e.g., components such as a steering system, a braking system, a powertrain, etc., and/or conditions such as vehicle 101 speed, acceleration, pitch, yaw, roll, etc. The computer 105 generally includes an autonomous driving module 106 that comprises instructions for autonomously, i.e., without operator input, operating the vehicle 101, including possibly in response to instructions received from a server 125. Further, the computer 105, e.g., in the module 106, generally includes instructions for receiving data, e.g., from one or more data collectors 110 and/or a human machine interface (HMI), such as an interactive voice response (IVR) system, a graphical user interface (GUI) including a touchscreen or the like, etc.

Autonomous steering operations in the vehicle 101 may be governed by one or more stored steering parameters 116. By evaluating collected data 115 with respect to one or more stored parameters 116 being used during autonomous driving operations, the computing device 105 can determine whether to adjust one or more of the parameters 116. For example, the module 106 may change a parameter 116 related to a rate at which a steering mechanism is turning the vehicle 101 wheels according to one or more environmental conditions or the like, e.g., wind, precipitation, etc. that may be detected or inferred by a data collector 110.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with the network 120, which, as described below, may include various wired and/or wireless networking technologies, e.g., cellular, Bluetooth, wired and/or wireless packet networks, etc.

Generally included in instructions stored in and executed by the computer 105 is an autonomous driving module 106. Using data received in the computer 105, e.g., from data collectors 110, data included as stored parameters 116, the server 125, etc., the module 106 may control various vehicle 101 components and/or operations without a driver to operate the vehicle 101. For example, the module 106 may be used to regulate vehicle 101 speed, acceleration, deceleration, steering, operation of components such as lights, windshield wipers, etc. Further, the module 106 may include instructions for evaluating information received in the computer 105 relating to vehicle 101 operator characteristics, e.g., from an HMI and/or data collectors 110.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LADAR, sonar, etc. sensors that could be deployed to measure a distance between the vehicle 101 and other vehicles or objects. Yet other sensor data collectors 110 could include cameras, breathalyzers, motion detectors, etc., i.e., data collectors 110 to provide data for evaluating a condition or state of a vehicle 101 operator. In addition, data collectors 110 may include sensors to detect a position, change in position, rate of change in position, etc., of vehicle 101 components such as a steering wheel, brake pedal, accelerator, gearshift lever, etc.

A memory of the computer 105 generally stores collected data 115. Collected data 115 may include a variety of data collected in a vehicle 101. Examples of collected data 115 are provided above, and moreover, data 115 is generally collected using one or more data collectors 110, and may additionally include data calculated therefrom in the computer 105, and/or at the server 125. In general, collected data 115 may include any data that may be gathered by a collection device 110 and/or computed from such data. Accordingly, collected data 115 could include a variety of data related to vehicle 101 operations and/or performance, as well as data related to environmental conditions, road conditions, etc. relating to the vehicle 101. For example, collected data 115 could include data concerning a vehicle 101 speed, acceleration, pitch, yaw, roll, braking, presence or absence of precipitation, tire pressure, tire condition, etc.

A memory of the computer 105 may further store steering parameters 116. A parameter 116 generally governs control of a vehicle 101 steering system, and is generally associated with an environmental condition, road condition, vehicle 101 condition, or the like. For example, a steering parameter 116 may specify an amount of force or speed of rotation to be applied to a vehicle 101 steering system, e.g., a steering wheel, either by default, or according to one or more environmental conditions, road conditions, vehicle 101 conditions, etc., e.g., an amount of vehicle yaw that could be caused by a high-crown road, cross-winds, etc., an intensity or type of precipitation, an unpaved road, worn tires, etc.

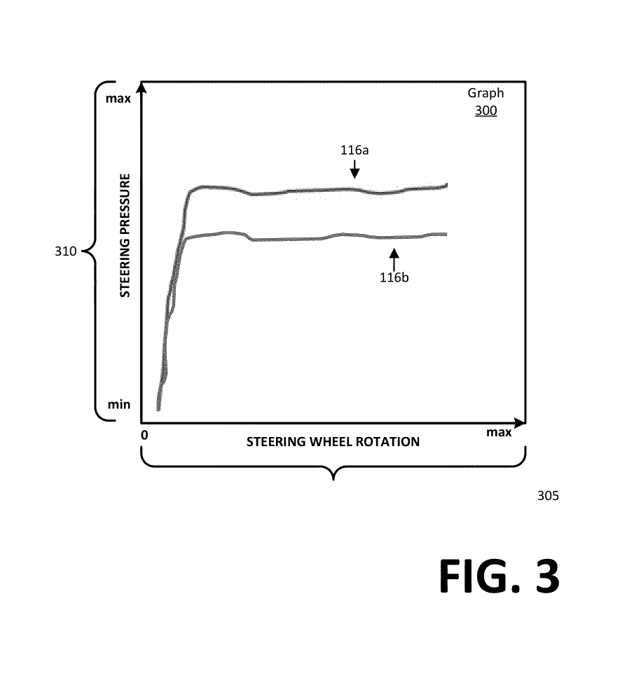

FIG. 3 illustrates a graph 300 showing plots of respective sets of steering parameters 116a, 116b, where each of the parameters 116a and 116b pertains an amount of steering assist force to be applied to a steering mechanism, e.g., a steering wheel, according to an autonomous driving mechanism such as the module 106, based on different respective environmental conditions and/or vehicle 101 speed or turn rate. Accordingly, an x-axis 305 of the graph 300 represents steering rotation, i.e., an amount that a steering mechanism will be rotated or turned when, under the environmental condition or conditions and/or vehicle 101 and/or turn rate represented by the respective parameters 116a, 116b, an amount of steering assist force represented by a y-axis 310 is applied. Different parameter sets 116 could be generated for different conditions that could be detected or inferred from collected data 115. For example, with reference to FIG. 3, the upper set of parameters 116a could govern under “normal” driving conditions, whereas the lower set of parameters 116b could apply under special driving conditions, e.g., slippery roads due to precipitation, a vehicle 101 having worn tires, when conditions such as cross-wins, etc. That is, the lower set of parameters 116b would be appropriate in conditions where relatively lower amounts of steering assist force were necessary or desirable for achieving a given steering wheel rotation. Further, less steering assist force may be necessary at higher vehicle 101 speeds, but greater steering assist force may be necessary for higher vehicle 101 turn rates, i.e., sharper turns.

It should be noted that parameters 116 are generally highly dependent on the design of a steering system in the vehicle 101. Different steering systems may have a different steering ratios (i.e., a ration of steering wheel rotation to actual vehicle 101 wheel movement). For example a 15:1 ratio will require more assist than a 18:1 ratio. Vehicle design more generally may be a dependency for parameters 116, e.g., an amount of weight shift (left side vs. right side) when vehicle 101 wheels are rotated may be relevant.

Returning to FIG. 1, the network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115 and/or parameters 116. For example, collected data 115 relating to road conditions, weather conditions, etc. could be stored in the data store 130, and provided by the server 125 to the computer 105. Likewise, parameters 116 could be provided from the data store 130 via the server 125. For example, parameters 116 could be updated for a particular vehicle 101 or type of vehicle 101, and then the updated parameters 116 could be provided to the module 106.

A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 150 may use such communication capabilities to communicate via the network 120 and also directly with a vehicle computer 105, e.g., using Bluetooth. Accordingly, a user device 150 may be used to carry out certain operations herein ascribed to a data collector 110, e.g., voice recognition functions, cameras, global positioning system (GPS) functions, etc., in a user device 150 could be used to provide data 115 to the computer 105. Further, a user device 150 could be used to provide a human machine interface (HMI) to the computer 105.

### Exemplary Process Flows

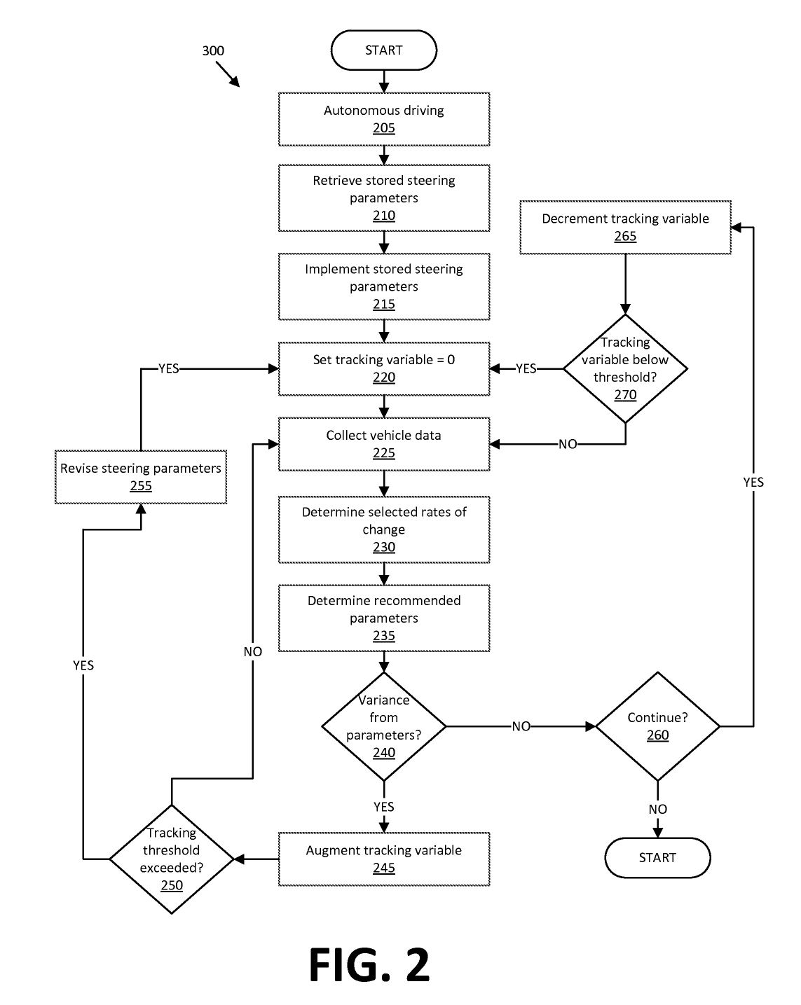

FIG. 2 is a diagram of an exemplary process 200 for monitoring and/or controlling steering in an autonomous vehicle.

The process 200 begins in a block 205, in which the vehicle 101 commences autonomous driving operations, i.e., begins driving in a manner partially or completely controlled by the autonomous driving module 106. For example, all vehicle 101 operations, e.g., steering, braking, speed, etc., could be controlled by the module 106 in the computer 105. However, it is also possible that, in the block 205, the vehicle 101 may be operated in a partially autonomous (i.e., partially manual, fashion, where some operations, e.g., braking, could be manually controlled by a driver, while other operations, e.g., including steering, could be controlled by the computer 105.

Following the block 205, or substantially contemporaneously with, or even immediately preceding, the block 205, in a block 210 the computer 105 retrieves stored steering parameters 116. As mentioned above, the parameters 116 govern control of a steering mechanism such as a steering wheel, steering column, etc. The parameters 116 retrieved in the block 210 are generally default parameters for a vehicle 101 type, although the parameters 116 may be further tailored for a particular geographic area, time of year, etc. Moreover, as mentioned above, the parameters 116 could be retrieved from the server 125. In any event, the parameters 116 generally specify, for a given vehicle speed, a steering assist force to be applied to the steering mechanism and/or a rate at which the steering mechanism should be turned. Parameters 116 could account for other factors, such as a vehicle 101 velocity, e.g., often it is desirable to turn a steering wheel faster at higher speeds than at slower speeds.

Next, in a block 215, the computer 105 implements the parameter or parameters 116 retrieved in the block 210. That is, during autonomous operations of the vehicle 101, steering is conducted according to these parameters 116. As mentioned above, the vehicle 101 may begin autonomous driving operations using a set of default parameters 116, although the initial parameters 116 may be adjusted for weather conditions, road conditions, etc. that are detected upon beginning autonomous driving. In any event, the object of selecting the default parameters 116 or other parameters 116 that may be used is to provide a safe and comfortable riding experience for occupants of an autonomous vehicle 101.

Next, in a block 220, the computer 105 sets a tracking variable to zero. If the block 220 is being visited for a first iteration of the process 200, then the tracking variable may be instantiated and initialized to zero. In subsequent iterations of the process 200, the tracking variable may be reset from some other value to which it has been adjusted as discussed further below.

Next, in a block 225, the computer 105 receives collected data 115. As mentioned above, collected data 115 may be provided via one or more of a variety of data collection devices 110, and may include data concerning vehicle 101 speed, pitch, yaw, roll, environmental conditions, road conditions, etc. Collected data 115 generally also includes a position of a steering mechanism, e.g., a steering wheel, steering column, etc.

Following the block 225, in a block 230, the computer 105 evaluates collected data 115 gathered as described with respect to the block 225. For example, the computer 105 generally identifies a rate of change of certain values of collected data 115, including the response of vehicle 101 to a steering input that been implemented by module 106 and the vehicle's 101 actual response by collecting data 115 such as vehicle speed, a turning rate and a yaw rate. That is, the computer 105 may determine if the vehicle 101 is in a process of turning, and if so what is the actual response, e.g., how quickly and sharply is the vehicle 101 turning. Further, data collectors 110 may be used to obtain collected data 115 showing a vehicle's 101 yaw over time, and, a yaw rate may also be calculated by the computer 105 from collected data 115.

Next, in a block 235, the computer 105 determines recommended parameters 116 according to the collected data 115 obtained as described with respect to the block 225, and evaluated as described with respect to the block 230. For example, the computer 105 may consult a table that associates parameters 116 for a vehicle 101 with a vehicle 101 speed, a yaw rate, a turning rate, and/or other factors such as environmental conditions, road conditions, etc.

Next, in a block 240, the computing device 105 determines whether the recommended parameters determined in the block 235 match or are within a specified percentage of the current parameters 116 implemented as described above with respect to the block 215, or a prior iteration of the block 255, discussed below. If the recommended parameters 116 do not vary from the current parameters 116, then a block 260 is executed next. Otherwise, the process 200 proceeds to a block 245.

In the block 245, the computer 105 augments the tracking variable described above. For example, the tracking variable may be a simple counter, and the block 245 may include incrementing the counter by the integer 1. However, the tracking variable could alternatively or additionally include tracking some other quantity, such as a passage of time from when the tracking variable was set to zero.

Following the block 245, in a block 250, the computer 105 determines whether a tracking threshold has been exceeded. That is, if the tracking variable exceeds a predetermined value, e.g., a predetermined amount of time, or consistency of observations, then it is likely desirable to implement the recommended parameters determined in the block 235. However, if a specified amount of time has not passed, or the tracking variable is otherwise determined not to exceed the predetermined threshold, then the process 200 returns to the block 225 to collect further vehicle 101 data 115. If the tracking threshold is exceeded, then a block 255 is executed next.

In the block 255, which may follow the block 250, the computer 105 revises operation of the module 106 to implement the parameters 116 determined in the block 235. The process 200 returns to the block 220 following the block 255.

A block 260 may follow the block 240. In the block 260, the computer 105 determines whether the process 200 should continue. Generally, the computer 105 may be configured to continue the process 200 as long as autonomous driving operations are being conducted. If autonomous driving ceases, then the process 200 may end. Otherwise, the process 200 may proceed to a block 265.

In the block 265, the computer 105 decrements the tracking variable. For example, if the tracking variable is a counter, it may be decremented by a value of the integer 1. Likewise, a predetermined amount of time could be subtracted from a time tracking variable. In any event, following the block 265, a block 270 is executed next.

In the block 270, the computer 105 determines whether the tracking variable is now below a predetermined threshold. For example, if a counter tracking variable is less than the value 1, or a time tracking variable is less than a predetermined amount of time, then the process 200 returns to the block 220. Otherwise, the process 200 returns to the block 225.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer in a vehicle, the computer comprising a processor and a memory, wherein the computer is configured to:
provide input to a vehicle steering mechanism for autonomous operation of the steering mechanism;
retrieve at least one first parameter for governing control of a steering mechanism;
apply the first parameter to operation of the steering mechanism;
collect data relating to operation of the vehicle; and
determine at least one second parameter for governing control of the steering mechanism.

2. The system of claim 1, the computer being further configured to:
compare the first parameter to the second parameter, and
apply the second parameter to operation of the steering mechanism according to the comparison.

3. The system of claim 1, wherein at least one of the parameters is a steering assist force to be applied to a steering mechanism.

4. The system of claim 1, wherein the second parameter is determined at least in part according to a speed of the vehicle.

5. The system of claim 1, wherein the second parameter is determined at least in part according to a turn rate of the vehicle.

6. The system of claim 1, wherein the collected data relates to at least one of a weather condition, a road condition, a condition of a vehicle component, and a metric related to operation of the vehicle.

7. The system of claim 6, wherein the collected data relates to the metric related to operation of the vehicle, and the metric related to operation of the vehicle is data concerning a yaw of the vehicle, the computer being further configured to:
compute a vehicle yaw rate for a vehicle turning operation; and
include the yaw rate in determining the second parameter.

8. A computer-readable medium tangibly embodying instructions executable by a computer processor, the instructions including instructions to:
provide input to a vehicle steering mechanism for autonomous operation of the steering mechanism;
retrieve at least one first parameter for governing control of a steering mechanism;
apply the first parameter to operation of the steering mechanism;
collect data relating to operation of the vehicle; and
determine at least one second parameter for governing control of the steering mechanism.

9. The medium of claim 8, the instructions further including instructions to:
compare the first parameter to the second parameter, and
apply the second parameter to operation of the steering mechanism according to the comparison.

10. The medium of claim 8, wherein at least one of the parameters is a steering assist force to be applied to a steering mechanism.

11. The medium of claim 8, wherein the second parameter is determined at least in part according to one of a speed of the vehicle and a turn rate of the vehicle.

12. The medium of claim 8, wherein the collected data relates to at least one of a weather condition, a road condition, a condition of a vehicle component, and a metric related to operation of the vehicle.

13. The medium of claim 12, wherein the collected data relates to the metric related to operation of the vehicle, and the metric related to operation of the vehicle is data concerning a yaw of the vehicle, the computer being further configured to:
compute a vehicle yaw rate for a vehicle turning operation; and
include the yaw rate in determining the second parameter.

14. A method, comprising:
providing input to a vehicle steering mechanism for autonomous operation of the steering mechanism;
retrieving at least one first parameter for governing control of a steering mechanism;
applying the first parameter to operation of the steering mechanism;
collecting data relating to operation of the vehicle; and
determining at least one second parameter for governing control of the steering mechanism.

15. The method of claim 14, further comprising:
comparing the first parameter to the second parameter, and
applying the second parameter to operation of the steering mechanism according to the comparison.

16. The method of claim 14, wherein at least one of the parameters is a steering assist force to be applied to a steering mechanism.

17. The method of claim 14, wherein the second parameter is determined at least in part according to a speed of the vehicle.

18. The method of claim 14, wherein the second parameter is determined at least in part according to a turn rate of the vehicle.

19. The method of claim 14, wherein the collected data relates to at least one of a weather condition, a road condition, a condition of a vehicle component, and a metric related to operation of the vehicle.

20. The method of claim 19, wherein the collected data relates to the metric related to operation of the vehicle, and the metric related to operation of the vehicle is data concerning a yaw of the vehicle, the method further comprising:
computing a vehicle yaw rate for a vehicle turning operation; and
including the yaw rate in determining the second parameter.
